(19) United States
(12) Patent Application Publication
(10) Pub. No.: US 2014/0250621 A1
(43) Pub. Date: Sep. 11, 2014

(54) WINDSHIELD WIPER ASSEMBLY

(71) Applicant: MITSUBA CORPORATION, Gunma (JP)

(72) Inventors: Tetsuya TAJIMA, Novi, MI (US); Takamichi IIZUKA, Novi, MI (US)

(73) Assignee: MITSUBA CORPORATION, Gunma (JP)

(21) Appl. No.: 13/790,180

(22) Filed: Mar. 8, 2013

(51) Int. Cl. B60S 1/08; H02K 5/10

(52) U.S. Cl. CPC B60S 1/08; H02K 5/10
USPC 15/250.31; 310/88

(57) ABSTRACT

A windshield wiper assembly for a vehicle includes a wiper motor having a casing and an output shaft, a crank arm coupled to the output shaft, and a link cover attached to the casing of the wiper motor by a clasp. The link cover shields the assembly from fluid, such as rain water, melting snow, washing fluid, and the like, and is easily attached to the wiper motor via the clasp without the need for specialized tools or the like.

### BACKGROUND

The present invention generally relates to a windshield wiper assembly and more particularly, to a link cover for a windshield wiper motor.

A windshield wiper assembly typically includes a wiper motor, one or more wiper blades secured to wiper arms, and a pivotable linkage mechanism therebetween.

The link mechanism is commonly composed of a plurality of interconnected link rods. At least one of the link rods is pivotally connected to the wiper motor. Rotational movement of the wiper motor is converted to pivotal movement of the link mechanism, which in turn pivots the wiper arms and blades. To improve the functionality and lifetime of the link rod to motor interface, grease is often applied to the interconnection between the link rod and wiper motor.

With the exception of the wiper arms and blades, the remainder of the windshield wiper assembly is mounted within the cowl box of the vehicle which is located forward of and lower than the windshield. As a result, fluid (e.g., rain water, melting snow, washing fluid, and the like) often flows from the windshield and into the cowl box through a plurality of openings provided in the cowl cover plate. Unfortunately, the fluid that flows through the openings and into the cowl box below the cover plate may splash onto the wiper motor and onto the interconnection between the link rod and the wiper motor. If too much fluid contacts the interconnection, the grease applied thereto may be displaced and proper rotation at the interconnection may be compromised.

### SUMMARY

One aspect of the invention overcomes many limitations and disadvantages of the related art wiper assembly for use in connection with a vehicle. To this end, a windshield wiper assembly for a vehicle is provided. The windshield wiper assembly includes a wiper motor having a casing and an output shaft, a crank arm coupled to the output shaft, and a link cover attached to the casing of the wiper motor by a clasp. Advantageously, the link cover shields the assembly from fluid, such as rain water, melting snow, washing fluid, and the like, and is easily attached to the wiper motor via the clasp without the need for specialized tools or the like.

### BRIEF DESCRIPTION OF THE DRAWINGS

FIG. 1 is a perspective view of cutting away a cowl cover plate which shows a wiper assembly in the mounting state according to an embodiment of the present invention.

FIG. 2 is a front view of the wiper assembly according to the embodiment of the present invention.

FIG. 3 is a rear view of the wiper assembly according to the embodiment of the present invention.

FIG. 4 is a perspective view of the wiper assembly seen from a clip portion of a link cover according to the embodiment of the present invention.

FIG. 5 is a front view of a wiper motor according to the embodiment of the present invention.

FIG. 6 is a side view of the wiper assembly seen from a hook shaped portion of the link cover according to the embodiment of the present invention.

FIG. 7 is a side view of the wiper assembly seen from a motor case according to the embodiment of the present invention.

FIG. 8 is a perspective view of the link cover according to the embodiment of the present invention.

FIG. 9 is a front view of the link cover according to the embodiment of the present invention.

FIG. 10A is an elevational view of partial cross section taken along line 10A-10A and seen from arrows in FIG. 9.

FIG. 10B is an elevational view of partial cross section taken along line 10B-10B and seen from arrows in FIG. 9.

FIG. 10C is an elevational view of partial cross section taken along line 10C-10C and seen from arrows in FIG. 9.

FIG. 10D is an elevational view of partial cross section taken along line 10D-10D and seen from arrows in FIG. 9.

FIG. 10E is a sectional view taken along line 10E-10E in FIG. 9.

FIG. 10F is an elevational view of partial cross section taken along line 10E-10F in FIG. 9.

FIG. 10G is an elevational view of partial cross section taken along line 10G-10G in FIG. 9.

FIG. 11 is a partial perspective view of an alternative embodiment of the clip portion of the circular broken line A in FIG. 8.

### DESCRIPTION OF EXEMPLARY EMBODIMENTS

An embodiment of the invention will be explained with reference to the drawings.

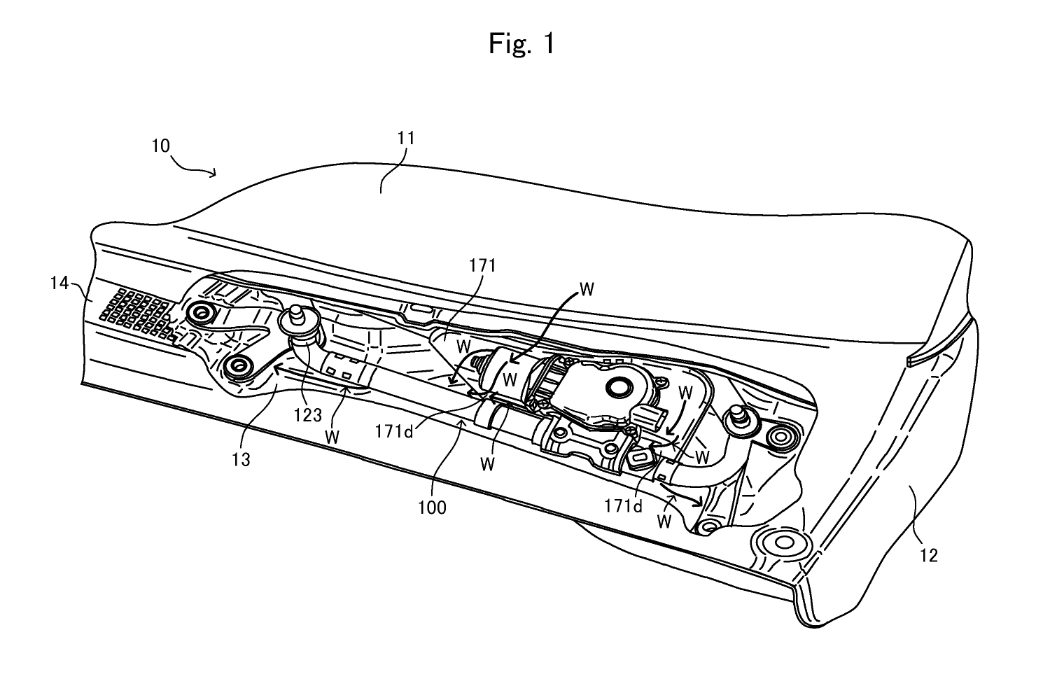

As shown in FIG. 1, a vehicle 10 includes a windshield 11 and a body panel 12. The body panel 12 includes a cowl box 13 and a cowl cover plate 14 which covers the cowl box 13. The cowl box 13 is located forward of and lower than the windshield 11. A wiper assembly 100 is mounted within the cowl box 13.

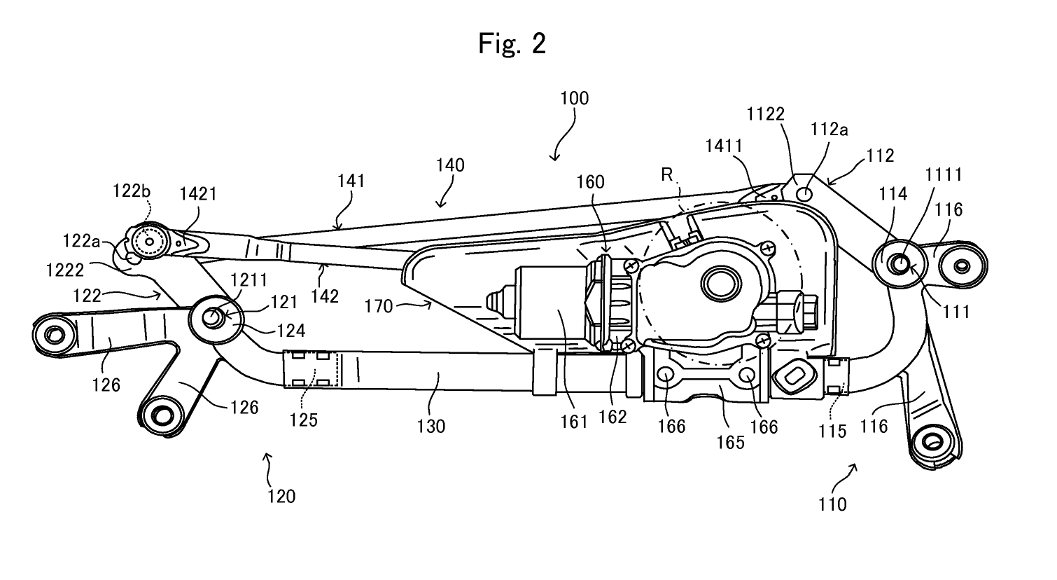

As shown in FIGS. 2 to 4, the wiper assembly 100 includes a first pivot assembly 110, a second pivot assembly 120, a frame 130, a link mechanism 140, a crank arm 150, a wiper motor 160 and a link cover 170. Details of each of these structures are described below.

The first pivot assembly 110 includes a first pivot shaft 111, a first pivot lever 112, a first shaft supporting portion 113, a first pivot cap 114, a first frame fixing portion 115, and first body fixing portions 116, 116.

The first pivot shaft 111 is preferably formed of metal, and has an elongated cylindrical shape. The first pivot lever 112 is preferably formed of metal, and has a rectangular and thin plate shape. A first end 1111 of the first pivot shaft 111 is coupled to a first end 1121 of the first pivot lever 112. A ball joint 112a is coupled to a second end 1122 of the first pivot lever 112. The link mechanism 140 is pivotally connected to the first pivot lever 112 via the ball joint 112a. The ball joint also includes what rotates in predetermined range corresponding to each lever.

The first shaft supporting portion 113 is preferably formed of metal or plastic, and has a cylindrical bore shape. The first pivot shaft 111 is inserted into the first shaft supporting portion 113 so that the first pivot shaft 111 is pivotally supported by the first shaft supporting portion 113. The first end 111 of the first pivot shaft 111 outwardly projects from an end face of the first shaft supporting portion 113. To facilitate the operation and lifetime of this interconnection, grease is applied between the first pivot shaft 111 and the first shaft supporting portion 113.

The first pivot cap 114 is attached to the first pivot shaft 111 or the first supporting portion 113 so that the grease is encased by the first pivot cap 114. By providing the first pivot cap 114, fluid (e.g., rain water) is prevented from splashing on or encroaching between the first pivot shaft 111 and the first shaft supporting portion 113. As such, the fluid cannot displace the grease and interrupt the operation of the first pivot shaft 111.

The first frame fixing portion 115 is preferably formed of metal or plastic and is integrally formed with the first shaft supporting portion 113 so that it projects outwardly from a side of the first shaft supporting portion 113. The first frame fixing portion 115 is coupled to the frame 130 by any suitable method of fixing such as press-fitting, staking, or via threaded fasteners.

The first body fixing portions 116, 116 are preferably formed of metal or plastic and are integrally formed with the first shaft supporting portion 113. The first body fixing portions 116, 116 are secured to the cowl box 13 by, for example, bolts. As such, the first frame fixing portion 115 is maintained stationary relative to the cowl box 13 while the first pivot lever 112 is pivotable about first pivot shaft 111.

As shown in FIGS. 1 to 3, the second pivot assembly 120 includes a second pivot shaft 121, a second pivot lever 122, a second shaft supporting portion 123, a second pivot cap 124, a second frame fixing portion 125, and second body fixing portions 126, 126.

The second pivot shaft 121 is preferably formed of metal, and has an elongated cylindrical shape. The second pivot lever 122 is preferably formed of metal, and has a rectangular and thin plate shape. A first end 1211 of the second pivot shaft 121 is coupled to a first end 1221 of the second pivot lever 122. A ball joint 122a is coupled to a second end 1222 of the second pivot lever 122. The link mechanism 140 is pivotally connected to the second pivot lever 122 via the ball joint 122a.

The second shaft supporting portion 123 is preferably formed of metal or plastic, and has a cylindrical bore shape. The second pivot shaft 121 is inserted into the second shaft supporting portion 123 so that the second pivot shaft 121 is pivotally supported by the second shaft supporting portion 123. A first end 1211 of the second pivot shaft 121 outwardly projects from an end face of the second shaft supporting portion 123. To facilitate the operation and lifetime of this interconnection, grease is applied between the second pivot shaft 121 and the second shaft supporting portion 123.

The second pivot cap 124 is attached to the second pivot shaft 121 or the second supporting portion 123 so that the grease is encased by the second pivot cap 124. By providing the second pivot cap 124, fluid (e.g., rain water) is prevented from splashing on or encroaching between the second pivot shaft 121 and the second shaft supporting portion 123. As such, the fluid cannot displace the grease and the operation of the second pivot shaft 121.

The second frame fixing portion 125 is preferably formed of metal or plastic and is integrally formed with the second shaft supporting portion 123 so that it projects outwardly from a side of the second shaft supporting portion 123. The second frame fixing portion 125 is coupled to the frame 130 by any suitable method of fixing such as press-fitting, staking, or via threaded fasteners.

The second body fixing portions 126, 126 are preferably formed of metal or plastic and are integrally formed with the second shaft supporting portion 123. The second body fixing portions 126, 126 are secured to the cowl box 13 by, for example, bolts. As such, the second frame fixing portion 125 is maintained stationary relative to the cowl box 13 while the second pivot lever 122 is pivotable about the second pivot shaft 121.

The frame 130 is preferably formed of metal and is generally an elongated cylinder, for example, 25 mm in diameter, with a circular cross-section that is cut to a predetermined length. The first frame fixing portion 115 is coupled to a first end of the frame 130 by, for example, press-fitting or staking. The second frame fixing portion 125 is coupled to the second end of the frame 130 by, for example, press-fitting or staking. As illustrated, the first and second frame fixing portions 115 and 125 may be inserted within the ends of the frame 130 to enhance the interconnection therebetween. The wiper motor 160 is coupled to the frame 130 between the first and second frame fixing portions 115 and 125 by, for example, bolts 166.

The link mechanism 140 includes a first link rod 141 and a second link rod 142. The first and second link rods 141 and 142 are preferably formed of metal although other materials may substitute therefor. A first end 1121 of the first pivot lever 112 is pivotally connected to a first end of the first link rod 141 via the ball joint 112a. Grease is applied to an interconnection C1 between the first end 1411 of the first link rod 141 and the ball joint 112a. The second end 1222 of the second pivot lever 122 is pivotally connected to the second end 1412 of the first link rod 141 via the ball joint 122a. Grease is also applied to an interconnection C2 between the second end 1412 of the first link rod 141 and the ball joint 122a.

The second end 1222 of the second pivot lever 122 is pivotally connected to a first end 1421 of the second link rod 142 via the ball joint 122b which is attached to the opposite side of the ball joint 122a. Grease is applied to an interconnection C3 between the first end 1421 of the second link rod 142 and the ball joint 122b. A first end 1501 of the crank arm 150 is pivotally connected to the second end 1422 of the second link rod 142. Grease is applied to an interconnection C4 between the second end 1422 of the second link rod 142 and the ball joint 150a.

The wiper motor 160 includes a motor case 161 coupled to a gear case 162. When the motor 160 is driven, an output shaft 163 which is accommodated in the gear case 162 rotates around the axis 164 of the output shaft 163. As the output shaft 163 rotates, the interconnection C4 moves along the rotational path R. A frame fixing portion 165 for coupling the gear case 162 to the frame 130 is integrally formed with the gear case 162. The gear case 162 is coupled to the frame 130 by bolts 166, 166 and nuts 167, 167 securing the frame fixing portion 165 to the frame 130.

The crank arm 150 is preferably metal, and has a rectangular plate shape. The distal end of the output shaft 163 is coupled to the second end 1502 of the crank arm 150. A ball joint 150a is coupled to the first end 1501 of the crank arm 150. The second end 1422 of the second link rod 142 is pivotally connected to the first end 1501 of the crank arm 150 via the ball joint 150a. Grease is applied to an interconnection C4 between the ball joint 150a and the second end 1422 of the second link rod 142.

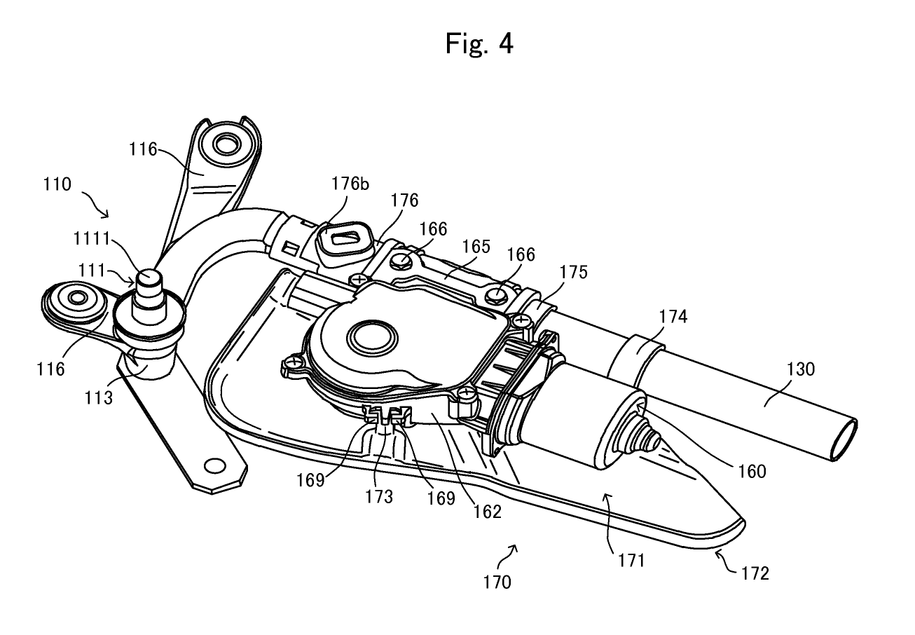

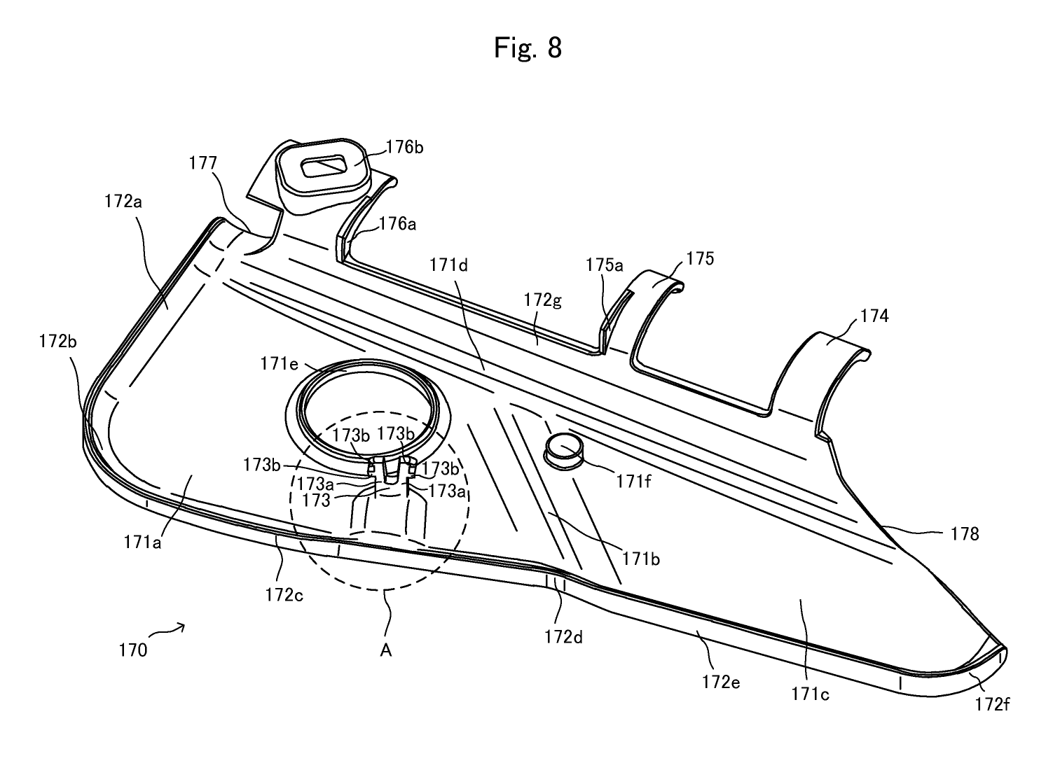

Referring to FIG. 4 and FIG. 8, the link cover 170 will be described in greater detail. The link cover 170 is preferably formed of plastic and has some flexibility. The link cover 170 is disposed next to the first pivot assembly 110 and includes a base or plate portion 171 and a wall portion 172.

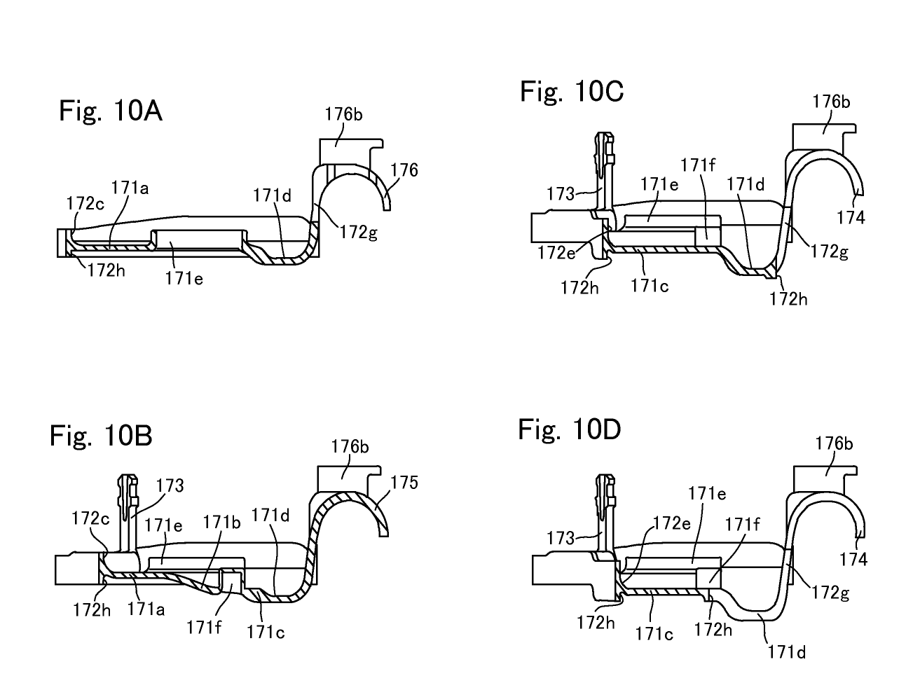

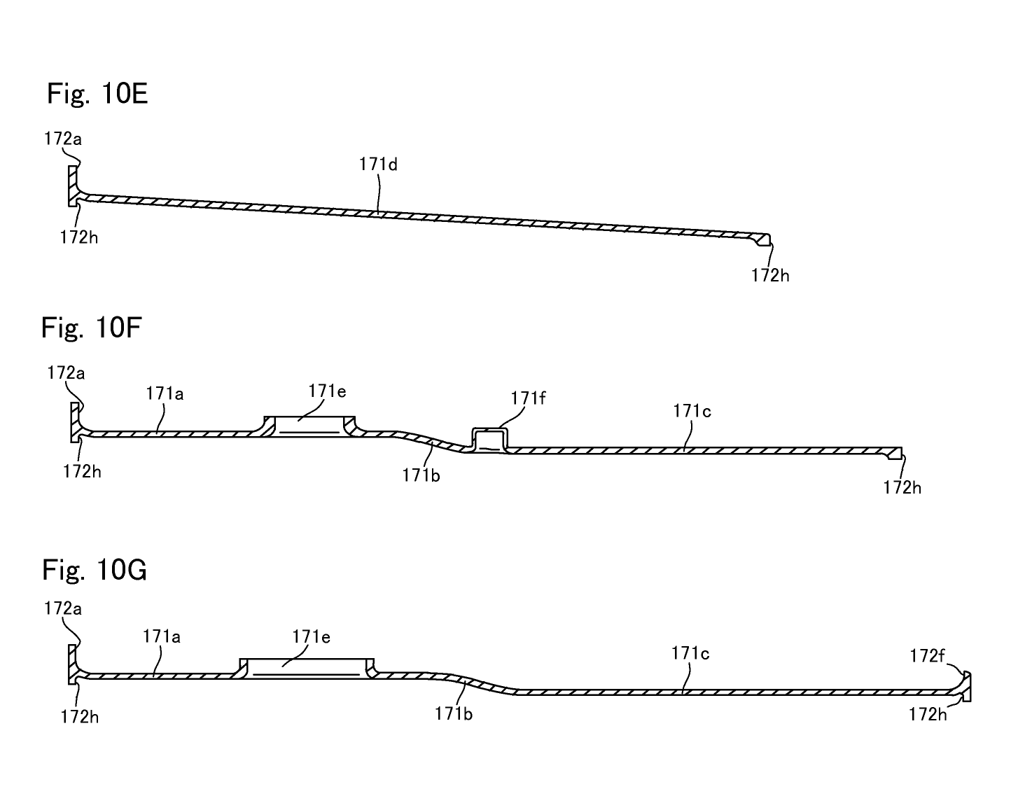

The plate portion 171 has a first plate portion 171a, a slope plate portion 171b extending from the first plate portion 171a, and a second plate portion 171c extending from the slope plate portion 171b. The first plate portion 171a, the slope plate portion 171b and the second plate portion 171c are continuous with one another and the transitions therebetween are integral and smooth. The first and second plate portions 171a and 171c are vertically offset from one another via the slope plate portion 171b. Each thickness of the first plate portion 171a, the slope portion 171b and the second plate portion is approximately 2.0 mm. The difference of the height between the first and second plate portions 171a and 171c is 6.0 mm. An angle between the slope portion 171b and the second plate portion 171c is approximately 155 degrees. See FIG. 10G. The link cover 170 also has a longitudinal channel 171d interconnecting the first and second drain portions 177 and 178, and located between the plate portion 171 and the hook shaped portions 174, 175, 176.

In the mounted state of the wiper assembly 100 shown in FIG. 1, the first plate portion 171a is located above the second plate portion 171c. As a result, fluid such as water flows from the first plate portion 171a toward the second plate portion 171c. The wall portion 172 has an upstanding or vertical wall extending along the first and second plate portions 171a and 171c, and along most of the periphery of the plate portion 171. More specifically, the wall portion 172 has a first straight wall portion 172a which extends vertically from the first plate portion 171a toward the wiper motor 160, a first curved wall portion 172b extends vertically from the first plate portion 171a toward the wiper motor 160 and has the radius of 30 mm, a second straight wall portion 172c which extends vertically from the first plate portion 171a toward the wiper motor 160, a slope wall portion 172d which extends vertically from the slope plate portion 171b toward the wiper motor 160, a third straight wall portion 172e which extends vertically from the second plate portion 171c toward the wiper motor 160, and a second curved portion 172f extends vertically from the second plate portion 171c toward the wiper motor 160 and has the radius of 20 mm. And a fourth straight wall portion 172g extends in the same direction of the first straight wall portion 172a and is formed along the longitudinal channel 171d. The first straight wall portion 172a, the first curved wall portion 172b, the second wall portion 172c, the slope wall portion 172d, the third wall portion 172e and the second curved portion 172f are continuously connected. Each wall portion 172a-172f has the height of approximately 6.0 mm from the face of the first plate portion 171a. The fourth wall portion 172g has the height of approximately 12 mm from the first plate portion 171a. The second straight wall portion 172c, the slope portion 172d and the third portion 172e are formed to fitting on the shape of the body panel 12 nearby the link cover 170. By providing the wall portion 172, fluid W which flows on the surface of the plate portion 171 is prevented from flowing to the interconnection C4.

The link cover 170 has an elastically-deformable clip portion 173 forming a clasp. The clasp is integrally formed with the link cover 170. The cover 170 is held to the casing of the wiper motor 160 by the clasp. Also, the link cover 170 has a first hook shaped portion 174, a second hook shaped portion 175 and a third hook shaped portion 176. The clip portion 173 has two laterally spaced apart finger portions 173a, 173a each terminating in two orthogonally projecting teeth 173b, 173b with a chamfered distal ends to enable the clip portion 173 to be easily snap-fit and removably attached to the gear case 162. The clip portion 173 has the height of 30 mm from the face of the first plate portion 171a. The elastically-deformable clip portion 173 is integrally formed with the link cover 170. Each finger portions 173a, 173a is flexible each other in direction of separating from or approaching. As used herein, the phrase removably attached means securable to and removable from a fixed state without the need for tools. As described in greater detail below, the first through third hook portions 174-176 lock onto the frame 130.

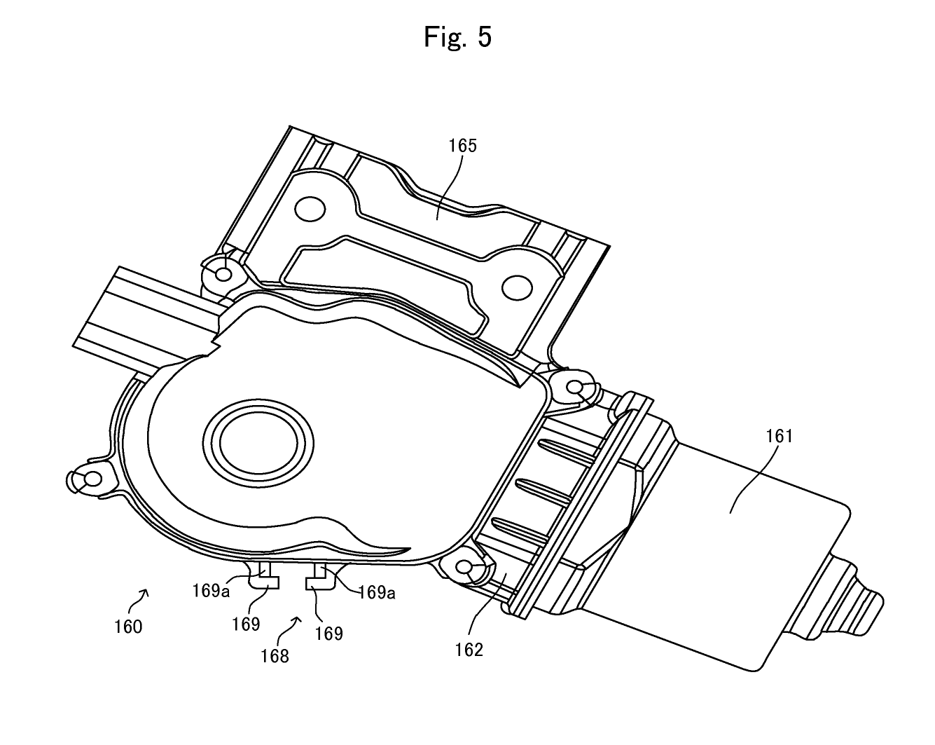

As shown in FIG. 5, the gear case 162 has an engaging portion 168 which is integrally formed with the gear case 162. The clip portion 173 may be removably attached to the engaging portion 168. As such, the link cover 170 is easily attached to the motor 160 by locking the first through third hook portions 174-176 over the frame 130, and then snap fitting the clip portion 173 into the engaging portion 168. As best seen in FIG. 5, the engaging portion 168 is preferably formed as an inverted U-shaped member including a symmetrical pair of inverted L-shaped portions 169, 169 on the side of the gear case 162. The gap between the L-shaped portions 169, 169 permits some adjusting of the size of the opening within the engaging portion 168 if desired to better accommodate the clip portion 173 therein. An interior surface of each L-shaped portion 169, 169 has a tooth 169a that nest between the teeth 173b, 173b of each finger portions 173a, 173a. It should be noted that while the clip portion 173 has been described as being attached to part of the gear case 162, the clip portion 173 may alternatively be attached to part of the motor case 161.

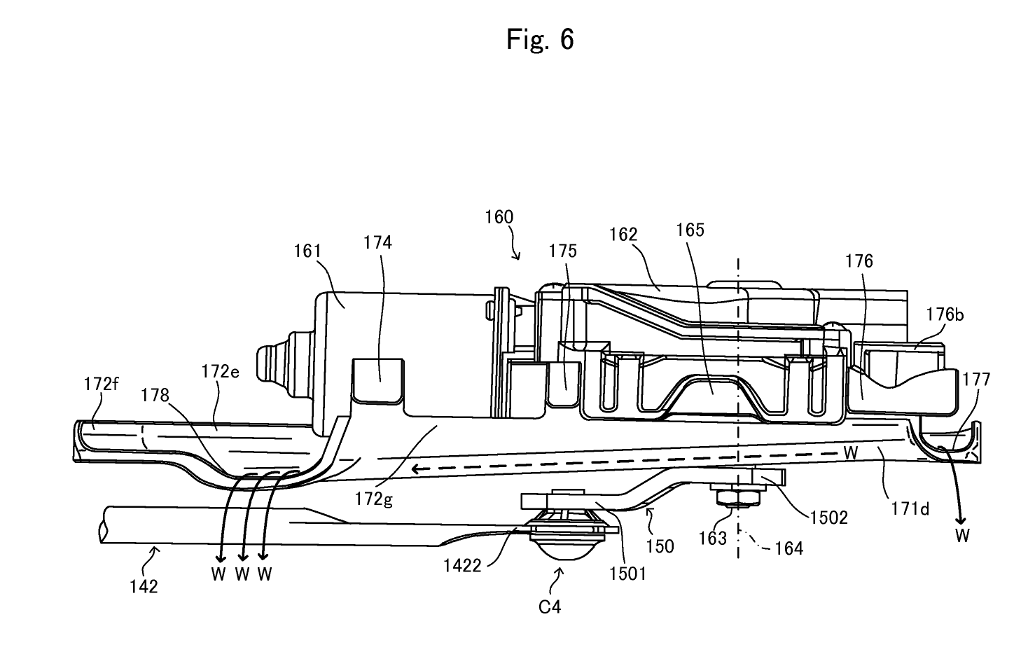

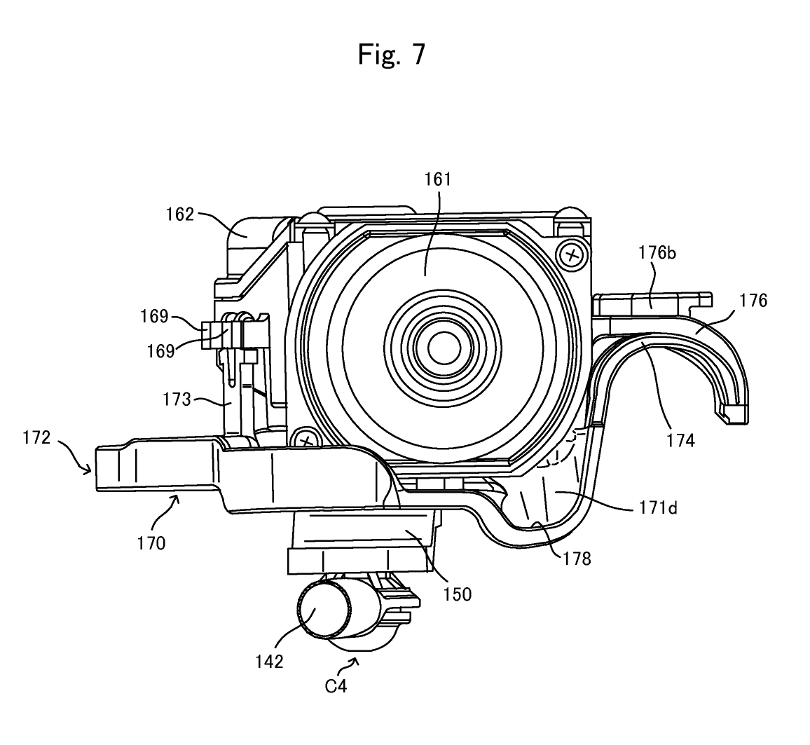

As shown in FIGS. 6 and 7, the link cover 170 is located between the crank arm 150 and the wiper motor 160. In other words, in the mounted state of the wiper assembly 100 shown in FIG. 1, the link cover 170 is above the crank arm 150, and below the wiper motor 160. The link cover 170 has a first drain portion 177 and a second drain portion 178. The first drain portion 177 is openings or cut outs formed between the first straight wall portion 172a and the fourth wall portion 172g. The second drain portion 178 is openings or cut outs formed between the second curved wall portion 172f and the fourth wall portion 172g. The first and second drain portions 177 and 178 are preferably located at corners of the plate portion 171. For example, the first drain portion 177 has the width of 15 mm at the end, and the depth of 2.0 mm from the first plate portion 171a. The second drain portion 178 has the width of 40 mm at the end, and the depth of 10 mm from the second plate portion 171c. The depth of the first drain portion 177 is 2.0 mm from the first plate portion 171a.

As shown in FIG. 6, after fluid (e.g., rain water) W flows from the windshield 11 to the link cover 170, the fluid W is drained outwardly from the first drain portion 177 or the second drain portion 178. In the mounted state of the wiper assembly 100 as shown in FIG. 1, the first drain portion 177 is located higher than the second drain portion 178. An angle between the face of the longitudinal channel 171d and the first plate portion 171a is approximately 4.0 degrees. In other words, an angle of inclination of the face of the longitudinal channel 171d relative to a horizontal surface is approximately 4.0 degrees. See FIG. 10E. As a result, as shown in FIG. 6, the amount of fluid W drained from the second drain portion 178 is greater than the amount of fluid W drained from the first drain portion 177.

Furthermore, the configuration of the first straight wall portion 172a greatly inhibits the fluid W is from splashing the interconnection C4. Also, water is prevented from splashing the second link rod 142, and is prevented from splashing the interconnection C4. As such, the path of rotation of the interconnection C4 may extend beyond the perimeter of the link cover 170 and this path need not be restricted to within the confines of the perimeter of the link cover 170. That is, as seen from the axis 164 of the output shaft 163, the link cover 170 does not need to cover an entirety of the rotational path R of the interconnection C4.

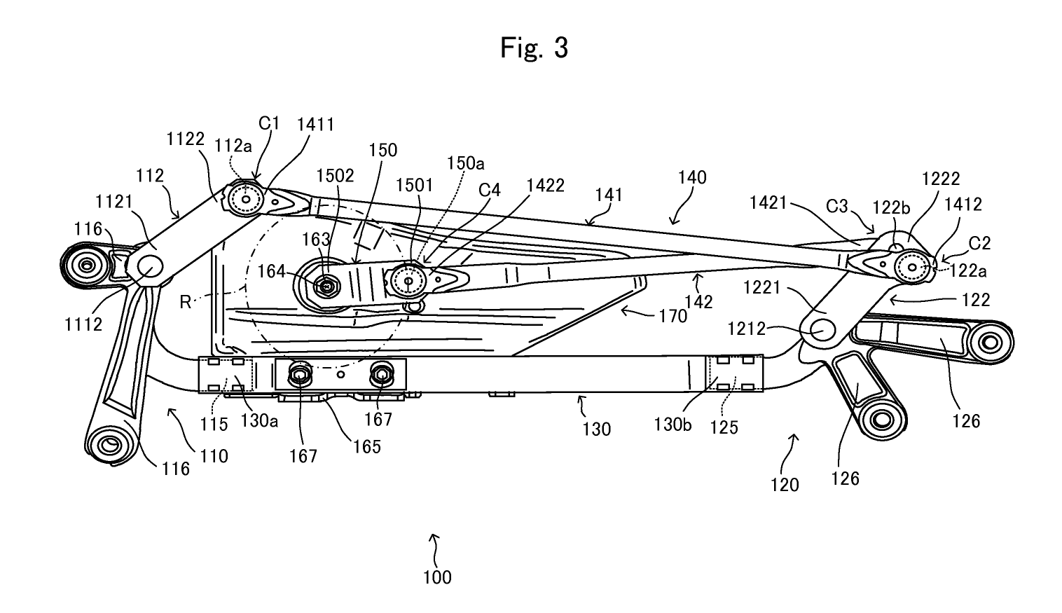

The first and second drain portions 177 and 178 are preferably spaced apart from the interconnection C4. As shown in FIG. 3, the surface area of the link cover 170 is larger than the projected area of the wiper motor 160 as seen from a longitudinal axis 164 of the output shaft 163. As a result, the fluid W flows outwardly from the link cover 170 without splashing the interconnection C4. Also, the fluid W is reliably drained outwardly from each of the first and second drain portions 177 and 178.

As shown in FIG. 8, the plate portion 171 has a hole formed therethrough which accommodates the output shaft 163. Thus, an inner diameter of the hole is larger than an outer diameter of the output shaft 163. The first plate portion 171a has an upstanding annular rib 171e entirely surrounding the hole inside diameter approximately 35 mm. The annular rib 171e extends from the first plate portion 171a toward the wiper motor 160. The annular rib 171e has the height of, for example, 5.0 mm, from the first plate portion 171a. By providing the annular rib 171e, the fluid W is prevented from flowing into the hole and onto the output shaft 153. By providing the link cover 170, the interconnection C4 of the crank arm 150 and the second link rod 142 is shielded from fluid.

The link cover 170 has a cylindrical-shaped projection 171f on the slope plate portion 171b and the second plate portion 171c. The cylindrical-shaped projection 171f has the height of 4.0 mm from the face of the second plate portion 171c. The cylindrical-shaped projection 171f is located between the clip portion 173 and the first through third hook portions 174-176. When the link cover 170 is attached to the gear case 162 by the clip portion 173 and to the frame 130 by the first through third hook portions 174-176, the cylindrical-shaped projection 171f contacts the gear case 162. In some embodiments, the cylindrical-shaped projection 171f acts a fulcrum against which the link cover 170 flexes which helps secure the link cover 170 in place.

More particularly, since the link cover 170 is preferably plastic, it has some elasticity. Thus, at the time the wiper motor 160 is attached to the link cover 170 by the clip portion 173, the cylindrical-shaped projection 171f makes contact with the gear case 162 and the position between the link cover 170 and the wiper motor 160 is defined. Further, at the time the wiper motor 170 is attached to the link cover 170 by the clip portion 173, the first through third hook portions 174-176 are biased against the frame 130 due to the leveraging effect caused by the abutment of the cylindrical-shaped projection 171f. As a result, vibrations between the link cover 170 and the wiper motor 160 are suppressed. Furthermore, the link cover 170 is easily and securely attached to the wiper motor 160 by the clip portion 173 and the first through third hook portions 174-176.

The first through third hook portions 174-176 integrally extend from the first straight wall portion 172a. Each hook portion 174-176 has a circular arc shape which corresponds to the outer surface shape of the frame 130, for example, 25 mm in diameter. Each hook portion 174-176 hooks over the frame 130. Further, each hook portion 174-176 is preferably located on the opposite side of the link cover 170 as the clip portion 173.

As shown in FIG. 2, the frame fixing portion 165 of the gear case 162 is arranged between the second and third hook portions 175 and 176. As a result, the position of the link cover 170 is regulated relative to the position of the wiper motor 160. Also, the second hook portion 175 has a second rib 175a which abuts the side of the frame fixing portion 165. The third hook portion 176 has a third rib 176a which abuts the side of the frame fixing portion 165. The second and third ribs 175a and 176a increase the surface area abutting the frame fixing portion 165 which improves performance and reliability. The third hook portion 176 has a wire fixing portion 176b to which a wire harness (not shown) for wiring supplying an operating current to the wiper motor 160 is attached.

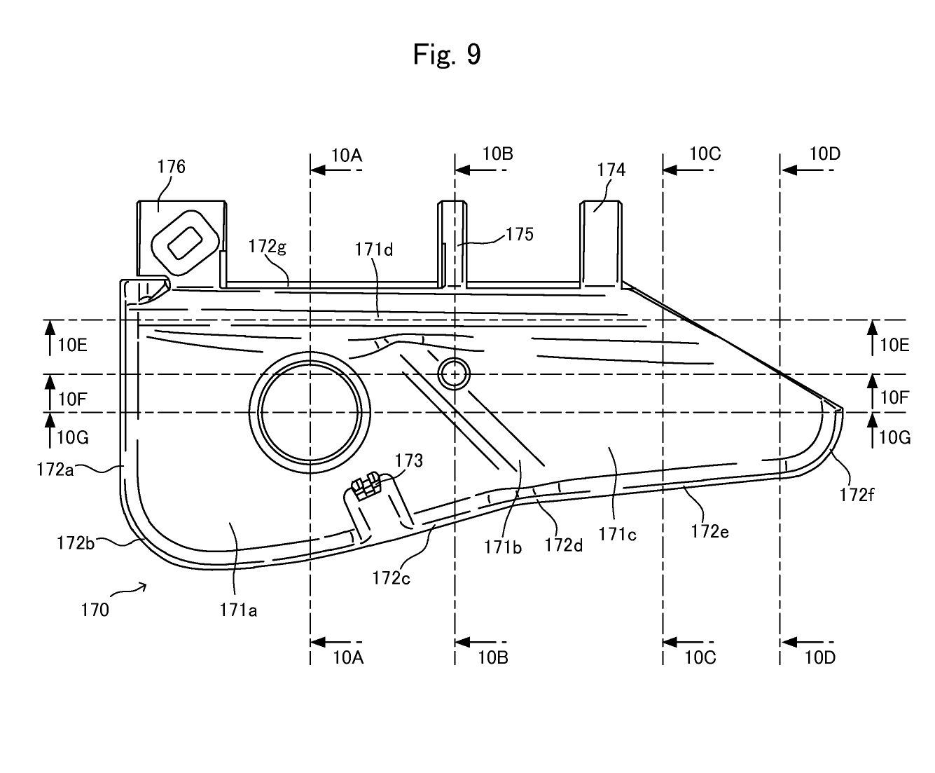

The configuration of the link cover 170 is shown in greater detail in FIGS. 9 to 10G. As illustrated, the link cover 170 has a slope plate portion 171b which extends continuously between the first and second plate portions 171a and 171c. The first straight wall portion 172a extends perpendicularly from the plate portion 171, and extends substantially vertically along the perimeter of the plate portion 171 when installed. The fifth wall portion 172h extends in the opposite direction of the each wall portion 172a-172f except for at the locations of the first through third hook portions 174-176. In other words, the fifth wall portion 172h extends away from the first plate portion 171a, the slope portion 171b and the second plate portion 171c. The fifth wall portion 172h reinforces the link cover 170 and shields from fluid. The annular rib 171e also extends perpendicularly from the first plate portion 171a and substantially vertically when installed.

The first straight wall portion 172a is formed around the link cover 170 except for at the locations of the first and second drain portions 177 and 178. As shown in FIG. 1, the longitudinal channel 171d is recessed relative to the first plate portion 171a, the slope plate portion 171b and the second plate portion 171c, and is sloped from the first drain portion 177 to the second drain portion 178. As a result, as shown in FIG. 6, fluid W flows from the plate portion 171 toward the longitudinal channel 171d, and is drained outwardly from the second drain portion 178.

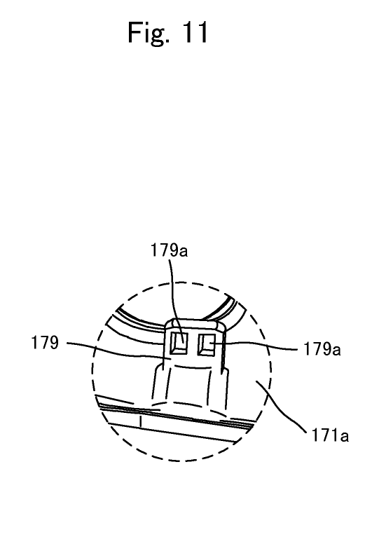

As shown in FIG. 11, instead of the elastically-deformable clip portion 173, a clip portion 179 having two holes 179a, 179a is shown. Each hole 179a, 179a has a rectangle shape, and the L-shaped portions 169, 169 of the gear case 162 are introduced therethrough. As a result, the link cover 170 is easily and securely attached to the wiper motor 160 by the clip portion 179.

The windshield wiper assembly and the cover for the windshield wiper motor being thus described, it will be apparent that the same may be varied in many ways. Such variations are not to be regarded as a departure from the spirit and scope of the invention, and all such modifications as would be apparent to one of ordinary skill in the art are intended to be included within the scope of the following claims.

What is claimed is:

1. A windshield wiper assembly, comprising:
a wiper motor having a casing and an output shaft;
a crank arm coupled to the output shaft; and
a cover attached to the casing of the wiper motor by a clasp.

2. The windshield wiper assembly according to claim 1,
wherein the cover is between the wiper motor and the crank.

3. The windshield wiper assembly according to claim 1, further comprising:
an attaching portion extending from the casing of the wiper motor and attached to the clasp.

4. The windshield wiper assembly according to claim 3,
wherein the attaching portion has an engaging projection.

5. The windshield wiper assembly according to claim 1,
wherein the wiper motor is coupled to a frame at a fixing portion, and the cover is attached to the frame.

6. The windshield wiper assembly according to claim 5, further comprising:
hook shaped portions extending from the cover and attached to the frame.

7. The windshield wiper assembly according to claim 6,
wherein the fixing portion is between a pair of the hook shaped portions.

8. The windshield wiper assembly according to claim 6,
wherein each of a pair of the hook shaped portions has a position regulating flange extending therefrom that directly contacts a side of the fixing portion.

9. The windshield wiper assembly according to claim 1,
wherein the cover includes:
a base; and
a wall extending from the base toward the wiper motor.

10. The windshield wiper assembly according to claim 9,
wherein the wall extends about a perimeter of the base and has at least one opening therein.

11. The windshield wiper assembly according to claim 10,
wherein the at least one opening is located in at least one corner of the wall.

12. The windshield wiper assembly according to claim 11,
wherein the cover has a longitudinal channel formed in the base and extending to the opening.

13. The windshield wiper assembly according to claim 12,
wherein the longitudinal channel is located adjacent the hook shaped portions.

14. The windshield wiper assembly according to claim 1,
wherein the cover includes:
a base; and
a wall extending away from the wiper motor.

15. The windshield wiper assembly according to claim 1,
wherein the cover has a hole therein,
the output shaft passes through the hole, and
an annular rib surrounds the hole and extends from the cover toward the wiper motor.

16. The windshield wiper assembly according to claim 1,
wherein a surface area of the cover is larger than a projected area of the wiper motor as seen from a longitudinal axis of the output shaft.

17. The windshield wiper assembly according to claim 1, further comprising:
a projection extending from the cover and directly contacting the wiper motor at a location spaced apart from the clasp.

18. The windshield wiper assembly according to claim 1,
wherein the clasp is integrally formed with the cover.

19. The windshield wiper assembly according to claim 1,
wherein the cover is plastic.

20. A windshield wiper assembly, comprising:
a wiper motor having a casing and an output shaft;
a crank arm coupled to the output shaft;
a link unit pivotally connected to the crank arm; and
a cover covering an interconnection between the link unit and the crank arm,
wherein the cover includes:
a base; and
a wall extending from the base toward the wiper motor.

21. The windshield wiper assembly according to claim 20, further comprising:
wherein the cover includes:
a wall extending from the base in the opposite direction of the wiper motor.

22. The windshield wiper assembly according to claim 20,
wherein the cover has the longitudinal channel formed in the base.

23. The windshield wiper assembly according to claim 20, further comprising:
a pivot assembly pivotally connected to the link unit,
a pivot shaft pivotally supported by the pivot assembly, and
a pivot cap covering the pivot shaft.

24. A cover for a windshield wiper motor having a casing and an output shaft, the cover comprising:
a base;
a wall extending from the base toward the wiper motor;
a clasp attachable to the casing.

25. The cover according to claim 24,
wherein the wall extends about a perimeter of the base and has at least one opening therein.

26. The cover according to claim 25,
wherein the cover has a longitudinal channel formed in the base and extending to the opening.

27. The cover according to claim 24, further comprising:
at least one hook shaped portion extending from the base on an opposite side as the clasp.

28. The cover according to claim 24,
wherein the cover has a hole therein for accommodating an output shaft of the wiper motor, and
an annular rib surrounds the hole and extends from the cover toward the wiper motor.

29. The cover according to claim 24,
wherein the cover is plastic.

30. The cover according to claim 24,
wherein the base includes:
a first base portion;
a sloped portion integrally extending at an angle from the first base portion; and
a second base portion integrally extending from the sloped portion.

31. The cover according to claim 30,
wherein the base has a longitudinal channel extending along the first base portion, the sloped portion, and the second base portion.
